(19) United States
(12) Patent Application Publication
(10) Pub. No.: US 2017/0069292 A1
(43) Pub. Date: Mar. 9, 2017

(54) IMAGE COMPENSATING DEVICE AND DISPLAY DEVICE HAVING THE SAME

(71) Applicant: SAMSUNG DISPLAY CO., LTD., Yongin-si (KR)

(72) Inventor: Hyeon-Ja JO, Cheongju-si (KR)

(21) Appl. No.: 15/141,876

(22) Filed: Apr. 29, 2016

(30) Foreign Application Priority Data
Sep. 9, 2015 (KR) 10-2015-0127682

(51) Int. Cl. G09G 5/04; G06T 7/40

(52) U.S. Cl. CPC G09G 5/04; G06T 7/408; G09G 2320/0242; G09G 2320/0666; G09G 2354/00

(57) ABSTRACT

An image compensating device includes an image detector, an environmental analyzer, and a compensation coefficient output. The image detector display one or more test images and collects image perception information from a user. The environmental analyzer analyzes an environment of the user based on the image perception information. The compensation coefficient output outputs a compensation coefficient that compensates image data based on the environment of the user.

### CROSS-REFERENCE TO RELATED APPLICATION

Korean Patent Application No. 10-2015-0127682, filed on Sep. 9, 2015, and entitled, “Image Compensating Device and Display Device Having the Same,” is incorporated by reference herein in its entirety.

### BACKGROUND

1. Field

One or more embodiments described herein relate to an image compensating device and a display device having an image compensating device.

2. Description of the Related Art

Mobile phones, personal digital assistants, and other types of portable terminals have a display panel which allows users to view desired content anytime and anywhere. The display panel is exposed to various environments because it is portable and mobile. The users may incorrectly perceive an image displayed on the display panel according to environment factors such as luminance or color temperature.

### SUMMARY

In accordance with one or more embodiments, an image compensating device includes an image detector to display one or more predetermined test images and to collect image perception information of a user when the one or more predetermined test images are displayed on a display panel; an environmental analyzer to analyze an environment of the user based on the image perception information; and a compensation coefficient output to output a compensation coefficient that compensates image data based on the environment of the user. The one or more predetermined test images may include a still image having at least two colors.

The image detector may query the user as to color of the one or more predetermined test images and is to receive an answer from the user. The environmental analyzer may classify the environment of the user as a red adjusted environment, a green adjusted environment, or a blue adjusted environment based on the image perception information.

The compensation coefficient output may output a first compensation coefficient that controls a gamma level of red image data in the image data when the environment of the user is the red adjusted environment. The compensation coefficient output may output a second compensation coefficient that controls a gamma level of green image data in the image data when the environment of the user is the green adjusted environment. The compensation coefficient output may output a third compensation coefficient that controls a gamma level of blue image data in the image data when the environment of the user is the blue adjusted environment. The image compensating device may be operated based on a predetermined cycle.

In accordance with one or more other embodiments, a display device includes a display panel including a plurality of pixels; an image compensator to display one or more test images on the display panel and to output a compensation coefficient that compensates image data by analyzing an environment of a user based on the one or more test images; a data driver to provide data signals to the display panel; a scan driver to provide a scan signal to the display panel; and a timing controller to generate a control signal that controls the image compensator, the data driver, and the scan driver.

The image compensator may include an image detector to display the one or more test images on the display panel and collect image perception information of the user when the one or more test images are displayed on the display panel; an environmental analyzer to analyze the environment of the user based on the image perception information; and a compensation coefficient output to output the compensation coefficient that compensates the image data based on the environment of the user. The one or more test images may include a still image having at least two colors.

The image detector may query the user of color of the one or more test images displayed on the display panel to and to receive an answer from the user. The environmental analyzer may classify the environment of the user into a red adjusted environment, a green adjusted environment, or a blue adjusted environment based on the image perception information. The compensation coefficient output may output a first compensation coefficient that controls a gamma level of red image data in the image data when the environment of the user is the red adjusted environment.

The compensation coefficient output may output a second compensation coefficient that controls a gamma level of green image data in the image data when the environment of the user is the green adjusted environment. The compensation coefficient output may output a third compensation coefficient that controls a gamma level of blue image data in the image data when the environment of the user is the blue adjusted environment. The image compensator may be operated based on a predetermined cycle.

The data driver may generate the data signals corresponding to the image data compensated based on the image compensation coefficient. The image compensator may be coupled to the data driver or located in the data driver. The image compensator may be coupled to the timing controller or located in the timing controller.

### BRIEF DESCRIPTION OF THE DRAWINGS

Features will become apparent to those of skill in the art by describing in detail exemplary embodiments with reference to the attached drawings in which:

FIG. 1 illustrates an embodiment of an image compensating device;

FIGS. 2A and 2B illustrate examples of the operation of an image detector;

FIG. 3 illustrates an example of the operation of an environmental analyzer;

FIG. 4 illustrates an example operation of the image compensating device;

FIG. 5 illustrates an embodiment of a display device;

FIG. 6 illustrates an embodiment of a display device; and

FIG. 7 illustrates an embodiment implemented as a smart phone.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

A person may distortedly perceive color when his eyes are adjusted to the surrounding environment. For example, the eyes may insensitively perceive red color in an object or an image when in an environment where red color light is emitted more than other colors. This is because the eyes adjust to the red color. In these circumstances, a person's eyes may distortedly perceive the color of image when the image displayed on the display panel includes red color. As a result, the user may think that the image quality of the display device is degraded.

To overcome these problems, an image compensating device according to one or more embodiments may display an image which is compensated based on the environment. This may be accomplished, for example, by receiving an image perception information of a user using test images, analyzing an environment of the user in which the user is stayed based on the image perception information, and outputting a compensation coefficient.

FIG. 1 illustrates an embodiment of an image compensating device 100, and

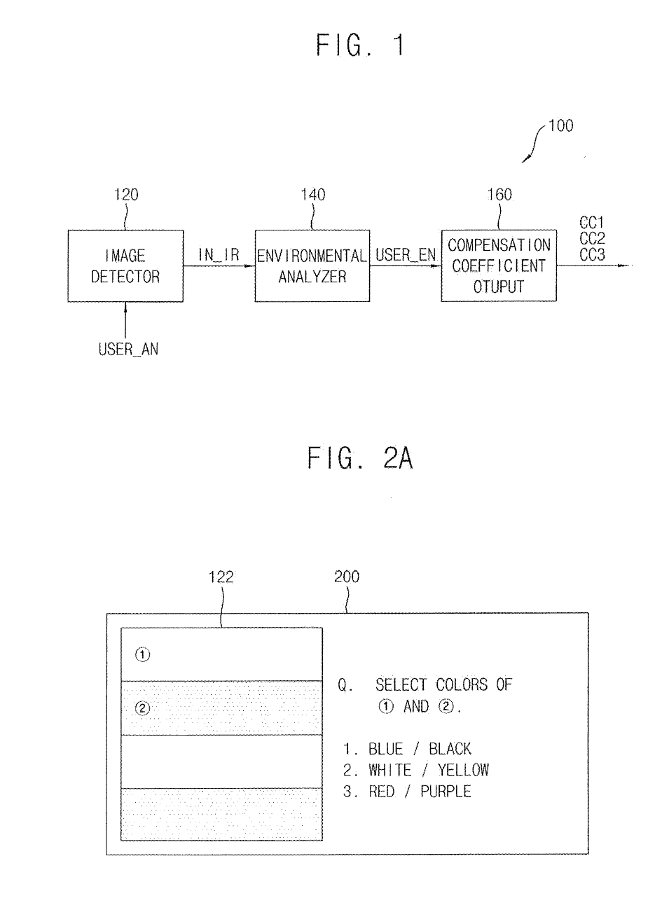

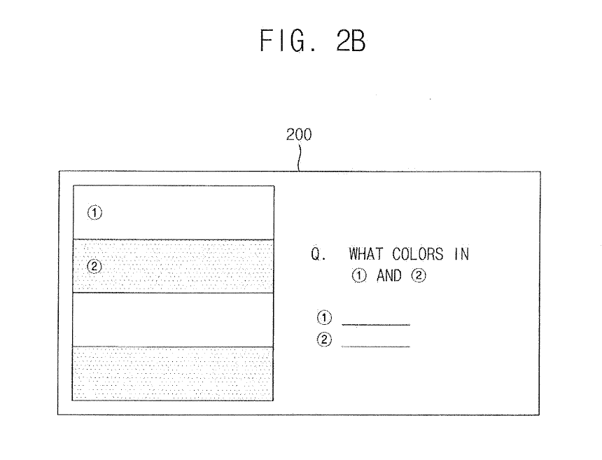

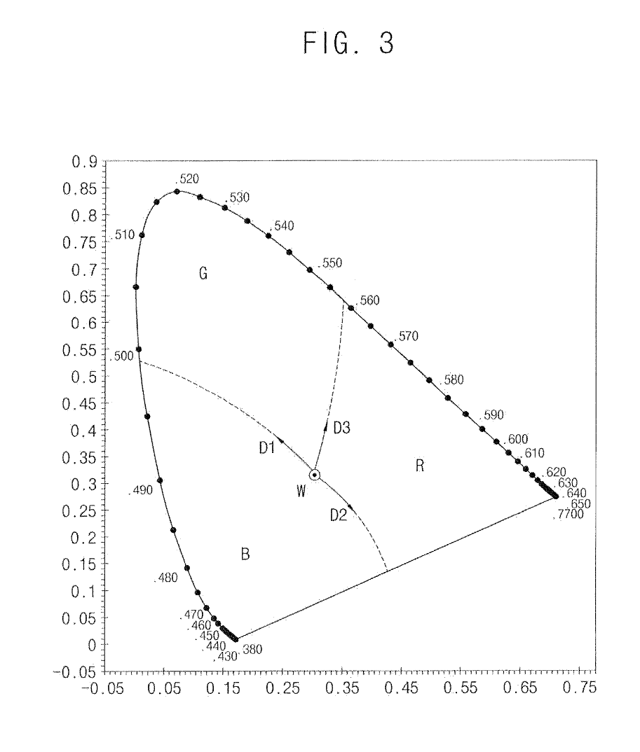

FIG. 2 illustrates an embodiment of an image detector 120 in the image compensating device 100.

Referring to FIG. 1, an image compensating device 100 may include the image detector 120, an environmental analyzer 140, and a compensation coefficient output 160.

The image detector 120 may display one or more predetermined test images 122 on the display panel 200 and collect image perception image information IN_IR of the user when each of the test images 122 is displayed on the display panel 200. The image detector 120 may query the user, for example, as to the color of the test image displayed on the display panel and may then receive the answer USER_AN of the user. The test image 122 may be, for example, a still image that includes at least two colors.

The image detector 120 may display each test image 122 on the display panel 200 and may query the user as to the color of the test image displayed on the display panel 200, for example, using an objective question as illustrated in FIG. 2A. For example, the first option may include the colors perceived by the user who is in an environment that includes more red color light than other colors. The second option may include the colors perceived by the user who is in an environment that includes more green color light than other colors. The third option may include the colors perceived by the user who is in an environment that includes more blue color light than other colors.

The user may provide the first option as the answer USER_AN when the user is in an environment that includes more red color light than other colors. The user may provide the second option as the answer USER_AN when the user is in an environment that includes more green color light than other colors. The user may provide the third option as the answer USER_AN when the user is in an environment that includes more blue color light than other colors.

Although three options are described in FIG. 2A, the number of options may not be limited thereto. For example, the options may further include the fourth option and the fifth option. The fourth option may include the colors perceived by the user who is in an environment that includes more yellow color light than other colors. The fifth option may include the colors perceived by the user who is in an environment that includes more purple color light than other colors. The user may select one of the options as the answer USER_AN using an input device, e.g., a keyboard, mouse, remote controller, keypad, etc.

In one embodiment, the image detector 120 may display the test image 122 on the display panel 200 and may query the user as to the color of the test image displayed on the display panel 200 using a subjective question, as illustrated in FIG. 2B. The user may input the answer USER_AN using an input device, e.g., keyboard, mouse, remote controller, keypad, etc. The image detector 120 may receive the answer USER_AN and provide the answer USER_AN as the image perception information IN_IR to the environmental analyzer 140.

The environmental analyzer 140 may analyze the environment of the user USER_EN based on the image perception information IN_IR. The environmental analyzer 140 may divide an environment of the user USER_EN into a red adjusted environment, a green adjusted environment, and a blue adjusted environment based on the image perception information IN_IR. The environmental analyzer 140 may analyze the environment of the user USER_EN based on the number of the answer of the user USER_AN (that is, the image perception information IN_IR). The environmental analyzer 140 may determine that the user is in the environment that has the largest number of the answer USER_AN. For example, the environmental analyzer 140 may analyze that the user is in an environment that includes more red color light than other colors when the user selects the largest number of the first option and may classify the environment as a red adjusted environment. The eyes of the user may be insensitive to the red color light in the red adjusted environment. For example, the user may perceive the color of the test image as if a white color coordinate W is moved to a first direction D1 in the red adjusted environment, for example, as described with reference to FIG. 3.

The environmental analyzer 140 may analyze that the user is in an environment that includes more green color light than other colors when the user selects the largest number of the second option and may classify the environment as a green adjusted environment. The eyes of the user may be insensitive to green color light in the green adjusted environment. For example, the user may perceive the color of the test image as if the white color coordinate W is moved to a second direction D2 in the green adjusted environment, for example, as described in FIG. 3.

The environmental analyzer 140 may analyze that the user is in an environment that includes more blue color light than other colors when the user select the largest number of the third option and may classify the environment as a blue adjusted environment. The eyes of the user may be insensitive to the blue color in the blue adjusted environment. For example, the user may perceive the color of the test image as if the white color coordinate W is moved to a third direction D3 in the blue adjusted environment, for example, as described in FIG. 3.

The compensation coefficient output 160 may output a compensation coefficient that compensates the image data based on the environment of the user USER_EN. The compensation coefficient output 160 may output a first compensation coefficient CC1 that controls a gamma level of red image data in the image data when the environment of the user USER_EN is classified as a red adjusted environment. For example, the red color of the image data may be emphasized because the user is insensitive to this color in the red adjusted environment. In one embodiment, the first compensation coefficient CC1 may be a signal that reduces the gamma level of the red image data.

The compensation coefficient output 160 may output a second compensation coefficient CC2 that controls a gamma level of green image data in the image data when the environment of the user USER_EN is classified as a green adjusted environment. For example, the green color of the image data may be emphasized because the user is insensitive to this color in the green adjusted environment. In one embodiment, the second compensation coefficient CC2 may be a signal that reduces the gamma level of the green image data.

The compensation coefficient output 160 may output a third compensation coefficient CC3 that controls a gamma level of blue image data in the image data when the environment of the user USER_EN is classified as a blue adjusted environment. For example, the blue color of the image data may be emphasized because the user is insensitive to this color in the blue adjusted environment. In one embodiment, the third compensation coefficient CC3 may be a signal that reduces the gamma level of the blue image data.

The compensation coefficient output 160 may include a storage device that stores the first compensation coefficient CC1 that controls the gamma level of the red image data, the second compensation coefficient CC2 that controls the gamma level of the green image data, and third compensation coefficient CC3 that controls the gamma level of the blue image data.

The image compensating device may be operated in a predetermined cycle or based on a setting of the user.

The image compensating device 100 may prevent a user from incorrectly perceiving an image displayed on the display panel according to the surrounding environment by displaying the predetermined test images 122 on the display panel, collecting the image perception information IN_IR of the user, analyzing the environment of the user USER_EN based on the image perception information IN_IR, and outputting the compensation coefficient CC1, CC2, CC3 to compensate the image data based on the environment of the user USER_EN. Thus, the display device that includes the image compensating device 100 may provide high-quality image regardless of the environment.

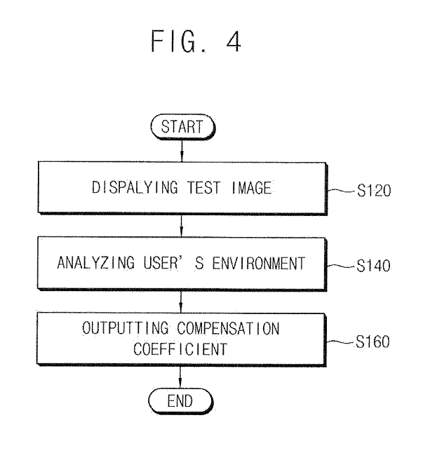

FIG. 4 illustrates an example of an operation performed by the image compensating device 100 in FIG. 1. Referring to FIG. 4, the image compensating device 100 may display a test image on the display panel (S120). The image compensating device may ask the user the color of the test image displayed on the display panel and may then receive image perception information which includes the answer to the question.

The image display device may analyze the environment of the user based on the image perception information (S140). The image compensating device may divide the environment of the user into a red adjusted environment, a green adjusted environment, and a blue adjusted environment based on the number of the answers (e.g., the image perception information).

The image compensating device may output a compensation coefficient that compensates the image data based on the environment of the user (S160). The image compensating device may output the first compensation coefficient that controls the gamma level of red image data when the environment of the user is classified as a red adjusted environment, the second compensation coefficient that controls the gamma level of green image data when the environment of the user is classified as a green adjusted environment, and the third compensation coefficient that controls the gamma level of blue image data when the environment of the user is classified as a blue adjusted environment. The image compensating device may be operated in a predetermined cycle or based on the setting of the user.

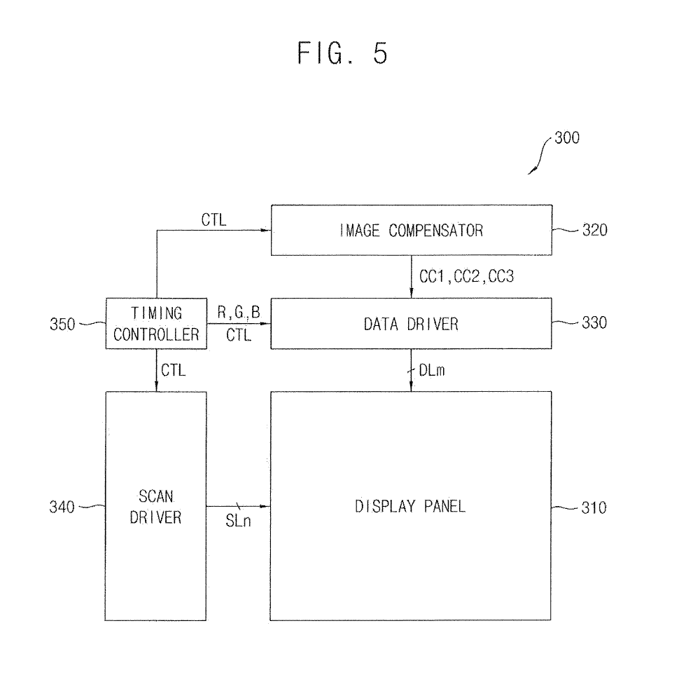

FIG. 5 illustrates an embodiment of a display device 300 which includes an image compensator 320, a data driver 330, a scan driver 340, and a timing controller 350. The image compensator 320 may correspond, for example, to the image compensating device 100 in FIG. 1.

The display panel 310 may include a plurality of pixels, a plurality of data lines DL, and a plurality of scan lines SL. The pixels may be formed in intersection regions of the data lines DLm and the scan lines SLn. In some example embodiments, each of the pixels includes a pixel circuit, a driving transistor, and an organic emitting diode. In this case, the driving transistor may control driving current flowing through the organic light emitting diode based on the data signal. The data signal may be provided to the driving transistor, via the data line DLm, in response to the scan signal and the scan signal is provided via the scan line SLn.

The image compensator 320 may display one or more predetermined test images on the display panel 310, analyze an environment of a user using the test images, and output a compensation coefficient that compensates image data. The image compensator 320 may include an image detector, an environmental analyzer, and a compensation coefficient output.

The image detector may display the predetermined test images on the display panel 310 and collect an image perception information of the user when each of the test image is displayed. The image detector may ask the user of the color of the test image when the test image is displayed on the display panel 310 and may receive an answer. The test images may be, for example, a still image that includes at least two colors.

The user may input different answers according to an environment (e.g., light device) in which the user uses the display device 300 even though the test image is the same. For example, the user may input different answers when the display device 300 is in an environment that includes more red color light than other colors and when the display device 300 is in an environment that includes more green color light than other colors, even though the test image is the same. The user may input the answer using an input device such as a keyboard, a mouse, a remote controller, a keypad, etc.

The image detector may receive the answers of the user by displaying the test images on the display panel 310 and provide the answers of the user to the environmental analyzer as image perception information. The environmental analyzer may divide the environment of the user into a red adjusted environment, a green adjusted environment, and a blue adjusted environment. The environmental analyzer may analyze the environment of the user based on the number of the answers of the user (that is, the image perception information). The environmental analyzer may determine that the user is in the environment corresponding to the largest number of the answer of the user.

The environmental analyzer may classify the environment of the user as a red adjusted environment when the environmental analyzer determines the user is in an environment that includes more red color light than other colors. The eyes of the user may be insensitive to the red color in the red adjusted environment.

The environmental analyzer may classify the environment of the user as a green adjusted environment when the environmental analyzer determines the user is in an environment that includes more green color light than other colors. The eyes of the user may be insensitive to the green color in a green adjusted environment.

The environmental analyzer may classify the environment of the user as a blue adjusted environment when the environmental analyzer determines the user is in an environment that includes more blue color light than other colors. The eyes of the user may be insensitive to the blue color in a blue adjusted environment.

The compensation coefficient output may output the compensation coefficient CC1, CC2, CC3 that compensates the image data R, G, B based on the environment of the user. The compensation coefficient output may output a first compensation coefficient CC1 that controls a gamma level of red image data R in the image data R, G, B when the environment of the user is classified as a red adjusted environment. For example, the red color of the image data R, G, B may be emphasized because the user is insensitive to this color in a red adjusted environment. In one embodiment, the first compensation coefficient CC1 may be a signal that reduces the gamma level of the red image data R.

The compensation coefficient output may output a second compensation coefficient CC2 that controls a gamma level of green image data G in the image data R, G, B when the environment of the user is classified as a green adjusted environment. For example, the green color of the image data R, G, B may be emphasized because the user is insensitive to this color in a green adjusted environment. For example, the second compensation coefficient CC2 may be a signal that reduces the gamma level of the green image data G.

The compensation coefficient output may output a third compensation coefficient CC3 that controls a gamma level of blue image data B in the image data R, G, B when the environment of the user is classified as a blue adjusted environment. For example, the blue color of the image data R, G, B may be emphasized because the user is insensitive to this color in the blue adjusted environment. In one embodiment, the third compensation coefficient CC3 may be a signal that reduces the gamma level of the blue image data B.

The compensation coefficient output may include a storage device that stores the first compensation coefficient CC1 that controls the gamma level of the red image data R, the second compensation coefficient CC2 that controls the gamma level of the green image data G, and third compensation coefficient CC3 that controls the gamma level of the blue image data B.

The scan driver 340 provides a scan signal to the pixels through the scan lines

SLn. The data driver 330 provides data signals to the pixels through the data lines DLm in response to the scan signal. The data driver 330 may control the gamma level of red image data R based on the first compensation coefficient CC1, the gamma level of green image data G based on the second compensation coefficient CC2, and the gamma level of blue image data B based on the third compensation coefficient CC3.

For example, the data driver 330 may reduce the gamma level of the red image data R in response to the first compensation coefficient CC1. The data driver 330 may reduce the gamma level of the green image data G in response to the second compensation coefficient CC2. The data driver 330 may reduce the gamma level of the blue image data B in response to the third compensation coefficient CC3.

The data driver 330 may generate the data signals to correspond to data voltages based on the image data R, G, B and the gamma levels compensated by the compensation coefficient CC1, CC2, CC3 from the image compensator 320.

The timing controller 350 may generate control signals CTL that control the image compensator 320, the scan driver 340, and the data driver 330. The image compensator 320 may be coupled to or located in the data driver 330. Further, the image compensator 320 may be coupled to or located in the timing controller 350.

As described above, the display device 300 according to example embodiments may display an image compensated according to the environment of the user by including the image compensator 320 that displays one or more predetermined test images on the display panel 310, collects the image perception information of the user, analyzes the environment of the user based on the image perception information, and outputs the compensation coefficient that compensates the image data R, G, B based on the environment of the user. Thus, the user may see the high-quality image regardless of the environment of the user.

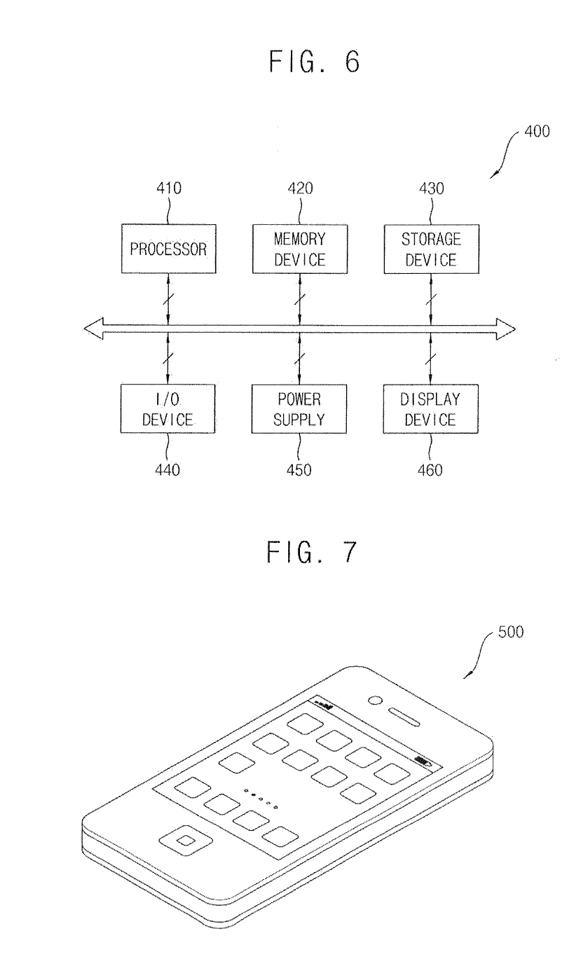

FIG. 6 illustrates an embodiment of an electronic device 400 that includes, for example, the display device of FIG. 5. FIG. 7 illustrates an example embodiment in which the electronic device of FIG. 6 is implemented as a smart phone.

Referring to FIGS. 6 and 7, the electronic device 400 may include a processor 410, a memory device 420, a storage device 430, an input/output (I/O) device 440, a power device 450, and a display device 460. The display device 460 may correspond, for example, to the display device 300 of FIG. 5. In addition, the electronic device 400 may include a plurality of ports for communicating a video card, a sound card, a memory card, a universal serial bus (USB) device, other electronic device, etc. Although FIG. 7 illustrates the electronic device 400 as a smart-phone 500, the electronic device 400 may be another type of device including or coupled to a display in another embodiment.

The processor 410 may perform various computing functions. The processor 410 may be a micro processor, a central processing unit (CPU), etc. The processor 410 may be coupled to other components via an address bus, a control bus, a data bus, etc. Further, the processor 410 may be coupled to an extended bus such as peripheral component interconnect (PCI) bus. The memory device 420 may store data for operations of the electronic device 400. For example, the memory device 420 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc, and/or at least one volatile memory device such as a dynamic random access memory (DRAM) device, a static random access memory (SRAM) device, a mobile DRAM device, etc. The storage device 430 may be a solid stage drive (SSD) device, a hard disk drive (HDD) device, a CD-ROM device, etc.

The I/O device 440 may be an input device such as a keyboard, a keypad, a touchpad, a touch-screen, a mouse, etc, and an output device such as a printer, a speaker, etc. In some example embodiments, the display device 460 may be in the I/O device 440. The power device 450 may provide a power for operations of the electronic device 400. The display device 460 may communicate with other components via the buses or other communication links. As described above, the display device 460 may include a display panel, an image compensator, a data driver, a scan driver, and a timing controller. The display panel may include a plurality of pixels. The image compensator may display a predetermined test images on the display panel, analyze the environment of the user using the test images, and output a compensation coefficient that compensates the image data.

The image compensator may correspond to any of the aforementioned embodiments. For example, the image compensator may include an image detector, an environmental analyzer, and a compensation coefficient output. The image detector may display one or more predetermined test images on the display panel and collect image perception information of the user when each of the test images are displayed on the display panel. The user may input answers for the question (e.g., “what is the color of the test image?”) using an input device such as a keyboard, a mouse, a remote controller, a keypad, etc.

The image detector may display the test images, receive the answers of the user, and provide the answers to the environmental analyzer as image perception information. The environmental analyzer may analyze the environment of the user based on the image perception information.

The environmental analyzer may divide the environment into a red adjusted environment, a green adjusted environment, and a blue adjusted environment based on the number of the answers (that is, the image perception information) of the user.

The compensation coefficient output may output the compensation coefficient that compensates the image data according to the environment of the user. The compensation coefficient output may output a first compensating coefficient that controls a gamma level of red image data when the environment of the user is classified as a red adjusted environment. The compensation coefficient output may output a second compensating coefficient that controls a gamma level of green image data when the environment of the user is classified as a green adjusted environment. The compensation coefficient output may output a third compensating coefficient that controls a gamma level of blue image data when the environment of the user is classified as a blue adjusted environment.

The data driver may control the gamma level of the red image data based on the first compensation coefficient, the gamma level of the green image data based on the second compensation coefficient, and the gamma level of the blue image data based on the third compensation coefficient. The data driver may generate data signals corresponding to data voltages based on the image data and the gamma levels compensated by the compensation coefficients from the image compensator. The scan driver may provide the scan signal to the pixels through the scan lines. The data driver may provide the data signals to the pixels through the data lines. The timing controller may generate the control signals that control the image compensator, the data driver, and the scan driver.

As described above, the electronic device 400 may display the image compensated based on the environment of the user by including the display device 460 that displays predetermined test images on the display panel, collects the image perception information of the user, analyzes the environment of the user based on the image perception information, and compensates the image data according to the environment of the user. Thus, the electronic device 400 that includes the display device 460 may display high-quality images regardless of the environment of the user.

The aforementioned embodiments may be applied to a display device and an electronic device having the display device. For example, the embodiments may be applied to a computer monitor, a laptop, a digital camera, a cellular phone, a smart phone, a smart pad, a television, a personal digital assistant (PDA), a portable multimedia player (PMP), a MP3 player, a navigation system, a game console, a video phone, etc.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

The compensators, analyzers, detectors, and other processing features of the embodiments described herein may be implemented in logic which, for example, may include hardware, software, or both. When implemented at least partially in hardware, the compensators, analyzers, detectors, and other processing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the compensators, analyzers, detectors, and other processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

By way of summation and review, a display panel is exposed to various environments because it is portable and mobile. Users may incorrectly perceive an image displayed on the display panel according to environment factors such as luminance or color temperature.

In accordance with one or more embodiments, an image compensating device may display one or more predetermined test images on the display panel, collect image perception information of a user, analyze the environment of the user based on the image perception information, and output the compensation coefficient that compensates the image data based on the environment of the user. Thus, a display device that includes the image compensating device may provide high-quality image regardless of the environment.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the embodiments as set forth in the claims.

What is claimed is:

1. An image compensating device, comprising:
an image detector to display one or more predetermined test images and to collect image perception information of a user when the one or more predetermined test images are displayed on a display panel;
an environmental analyzer to analyze an environment of the user based on the image perception information; and
a compensation coefficient output to output a compensation coefficient that compensates image data based on the environment of the user.

2. The image compensating device as claimed in claim 1, wherein the one or more predetermined test images include a still image having at least two colors.

3. The image compensating device as claimed in claim 1, wherein the image detector is to query the user as to color of the one or more predetermined test images and is to receive an answer from the user.

4. The image compensating device as claimed in claim 1, wherein the environmental analyzer is to classify the environment of the user as a red adjusted environment, a green adjusted environment, or a blue adjusted environment based on the image perception information.

5. The image compensating device as claimed in claim 4, wherein the compensation coefficient output is to output a first compensation coefficient that controls a gamma level of red image data in the image data when the environment of the user is the red adjusted environment.

6. The image compensating device as claimed in claim 4, wherein the compensation coefficient output is to output a second compensation coefficient that controls a gamma level of green image data in the image data when the environment of the user is the green adjusted environment.

7. The image compensating device as claimed in claim 4, wherein the compensation coefficient output is to output a third compensation coefficient that controls a gamma level of blue image data in the image data when the environment of the user is the blue adjusted environment.

8. The image compensating device as claimed in claim 1, wherein the image compensating device is to be operated based on a predetermined cycle.

9. A display device, comprising:
a display panel including a plurality of pixels;
an image compensator to display one or more test images on the display panel and to output a compensation coefficient that compensates image data by analyzing an environment of a user based on the one or more test images;
a data driver to provide data signals to the display panel;
a scan driver to provide a scan signal to the display panel; and
a timing controller to generate a control signal that controls the image compensator, the data driver, and the scan driver.

10. The display device as claimed in claim 9, wherein the image compensator includes:
an image detector to display the one or more test images on the display panel and collect image perception information of the user when the one or more test images are displayed on the display panel;
an environmental analyzer to analyze the environment of the user based on the image perception information; and
a compensation coefficient output to output the compensation coefficient that compensates the image data based on the environment of the user.

11. The display device as claimed in claim 10, wherein the one or more test images include a still image having at least two colors.

12. The display device as claimed in claim 10, wherein the image detector is to query the user of color of the one or more test images displayed on the display panel to and to receive an answer from the user.

13. The display device as claimed in claim 10, wherein the environmental analyzer is to classify the environment of the user into a red adjusted environment, a green adjusted environment, or a blue adjusted environment based on the image perception information.

14. The display device as claimed in claim 13, wherein the compensation coefficient output is to output a first compensation coefficient that controls a gamma level of red image data in the image data when the environment of the user is the red adjusted environment.

15. The display device as claimed in claim 13, wherein the compensation coefficient output is to output a second compensation coefficient that controls a gamma level of green image data in the image data when the environment of the user is the green adjusted environment.

16. The display device as claimed in claim 13, wherein the compensation coefficient output is to output a third compensation coefficient that controls a gamma level of blue image data in the image data when the environment of the user is the blue adjusted environment.

17. The display device as claimed in claim 9, wherein the image compensator is to be operated based on a predetermined cycle.

18. The display device as claimed in claim 9, wherein the data driver is to generate the data signals corresponding to the image data compensated based on the image compensation coefficient.

19. The display device as claimed in claim 9, wherein the image compensator is coupled to the data driver or located in the data driver.

20. The display device as claimed in claim 9, wherein the image compensator is coupled to the timing controller or located in the timing controller.
